(19) United States
(12) Patent Application Publication
(10) Pub. No.: US 2014/0006932 A1
(43) Pub. Date: Jan. 2, 2014

(54) WEB PAGE UPDATE NOTIFICATION DEVICE AND WEB PAGE UPDATE NOTIFICATION METHOD

(71) Applicant: FUJITSU LIMITED, Kawasaki (JP)

(72) Inventors: Yutaka YAMANAKA, Kannami (JP); Morihisa Kawai, Kawasaki (JP); Masahiro Shitashimo, Toyama (JP); Masaaki Uchijima, Takaoka (JP)

(73) Assignee: FUJITSU LIMITED, Kawasaki (JP)

(21) Appl. No.: 14/015,418

(22) Filed: Aug. 30, 2013

Related U.S. Application Data
(63) Continuation of application No. PCT/JP2011/054654, filed on Mar. 1, 2011.

(51) Int. Cl. G06F 17/22

(52) U.S. Cl. CPC G06F 17/2247
USPC 715/234

(57) ABSTRACT

A web page update notification device includes a detecting unit configured to detect at least one updated configuration element of a plurality of configuration elements of a web page based on content of communication of a web browser and a web server that provides the plurality of configuration elements of the web page; and a notifying unit configured to display the updated configuration element differently from other configuration elements of the plurality of configuration elements.

### CROSS-REFERENCE TO RELATED APPLICATION

This application is a U.S. continuation application filed under 35 USC 111(a) claiming benefit under 35 USC 120 and 365(c) of PCT Application JP2011/054654 filed on Mar. 1, 2011, the entire contents of which are incorporated herein by reference.

### FIELD

The embodiments discussed herein are related to a web page update notification device and a web page update notification method.

### BACKGROUND

Presently, various kinds of information are open to the public by web pages. Furthermore, various business transactions are performed via web pages. Generally, web pages are managed or generated at a web server. When viewing a web page, the web page is acquired from a web server, and is displayed by a web browser. Therefore, by rewriting the contents of the web page at the web server, the information disclosed by the web page of the same URL may be easily changed. That is to say, a web page identified by the same URL may have different contents depending on the time when the web page is accessed.

In view of properties relevant to the web page, in the conventional technology, studies are made on a technology for presenting update information of the web page (see for example, Patent Documents 1 and 2).

Patent Document 1: Japanese Laid-Open Patent Publication No. 2003-256316

Patent Document 2: Japanese Laid-Open Patent Publication No. 2002-259199

However, in the technology disclosed in Patent Documents 1 and 2, a program different from the web browser periodically accesses a predetermined URL to present the update information of the web page relevant to the predetermined URL. Therefore, when the contents of a web page presently being displayed by the web browser are updated, the user is unable to immediately recognize the updated portion. As examples of a web page whose contents may be updated while being displayed, there are web pages that are updated at relatively short intervals, such as web pages relevant to net auctions, blogs, and stock prices.

### SUMMARY

According to an aspect of the embodiments, a web page update notification device includes a detecting unit configured to detect at least one updated configuration element of a plurality of configuration elements of a web page based on content of communication of a web browser and a web server that provides the plurality of configuration elements of the web page; and a notifying unit configured to display the updated configuration element differently from other configuration elements of the plurality of configuration elements.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 illustrates a configuration of a web system according to an embodiment of the present invention;

FIG. 2 illustrates a hardware configuration of a client device according to an embodiment of the present invention;

FIG. 3 illustrates a software configuration of the client device according to an embodiment of the present invention;

FIG. 4 is a flowchart for describing processing procedures of a web page displaying process;

FIG. 5 illustrates an example of the configuration information of a web page;

FIG. 6 is a flowchart describing processing procedures of a process of detecting the update of a web page and notifying the detected update;

FIG. 7 illustrates the configuration of a setting file;

FIG. 8 illustrates a display example of a setting dialog of an update notification invalidation flag and an update notification invalidation element;

FIG. 9 is a flowchart for describing the relationship between the setting contents in a setting dialog and the setting contents in the setting file;

FIG. 10 is a flowchart for describing processing procedures of a preview display process; and

FIG. 11 illustrates a display example of a preview screen.

### DESCRIPTION OF EMBODIMENTS

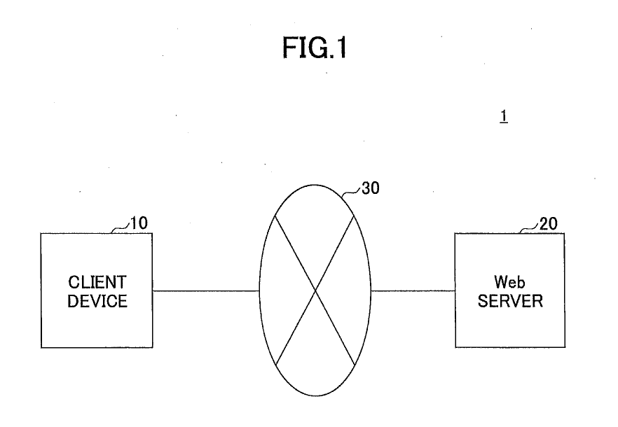

Preferred embodiments of the present invention will be explained with reference to accompanying drawings. FIG. 1 illustrates a configuration of a web system according to an embodiment of the present invention. In the web system 1 in FIG. 1, a web server 20 and a client device 10 are connected so that communication is possible via a network 30 (wired or wireless) such as a LAN (Local Area Network) or the Internet. In the present embodiment, the client device 10 is an example of a web page update notification device.

The web server 20 is a computer for providing web pages. For example, the web server 20 receives a request (for example, a HTTP (HyperText Transfer Protocol) request from the client device 10, and the web server 20 returns, to the client device 10, a web page relevant to a URL (Uniform Resource Locator) specified in the request. The web page may be saved in the web server 20 in advance, or may be dynamically generated in response to a request from the client device 10. A web page is display data described in, for example, HTML (HyperText Markup Language). The data format of the web page is not limited to HTML. The data format may be XML (extensible Markup Language) or another data format.

The client device 10 is a computer for displaying the web page provided from the web server 20. Examples of the client device 10 are a PC (Personal Computer), a PDA (Personal Digital Assistance), a mobile phone, or a smartphone.

In FIG. 1, one of each of the web server 20 and the client device 10 are illustrated; however a plurality of the web servers 20 and a plurality of the client devices 10 may be included in the web system 1.

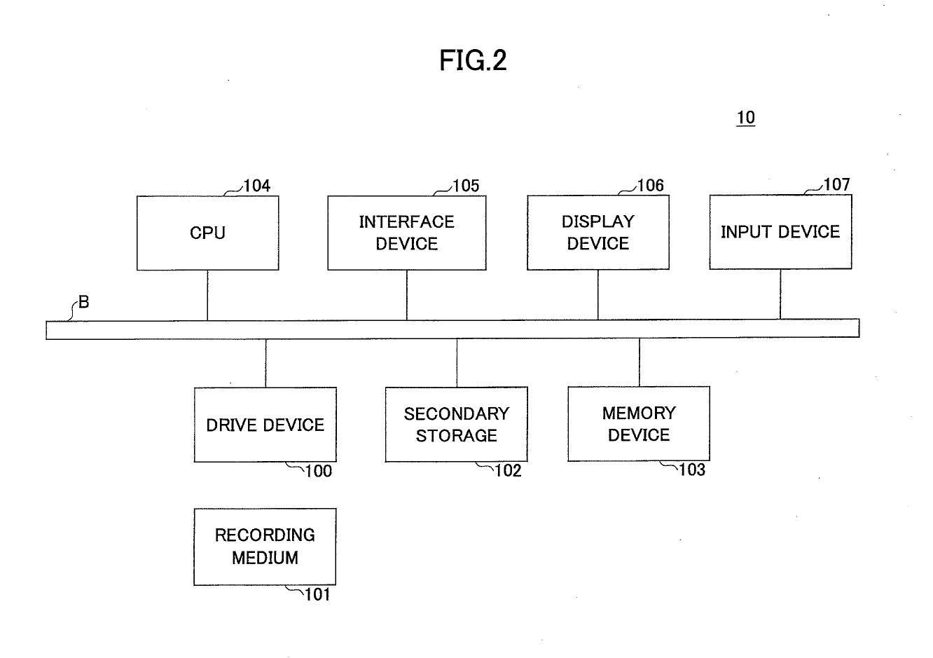

FIG. 2 illustrates a hardware configuration of the client device 10 according to an embodiment of the present invention. The client device 10 illustrated in FIG. 2 includes a drive device 100, a secondary storage 102, a memory device 103, a CPU 104, an interface device 105, a display device 106, and an input device 107, which are interconnected by a bus B.

A program for realizing a process at the client device 10 is provided by a recording medium 101. When the recording medium 101 recording the program is set in the drive device 100, the program is installed in the secondary storage 102 from the recording medium 101 via the drive device 100. However, the program may be installed without using the recording medium 101; the program may be downloaded from another computer via a network. The secondary storage 102 stores the installed program as well as files and data to be used.

The memory device 103 reads a program from the secondary storage 102 when an instruction to activate the program is given, and stores the program. The CPU 104 realizes functions relevant to the client device 10, according to the program stored in the memory device 103. The interface device 105 is used as an interface for connecting to the network. The display device 106 displays a GUI (Graphical User Interface) according to a program.

The input device 107 includes a keyboard and a mouse, and is used for inputting various operation instructions.

Examples of the recording medium 101 are portable recording media such as a CD-ROM, a DVD, and a USB memory. Examples of the secondary storage 102 are a HDD (Hard Disk Drive) and a flash memory. Both the recording medium 101 and the secondary storage 102 correspond to a computer-readable recording medium.

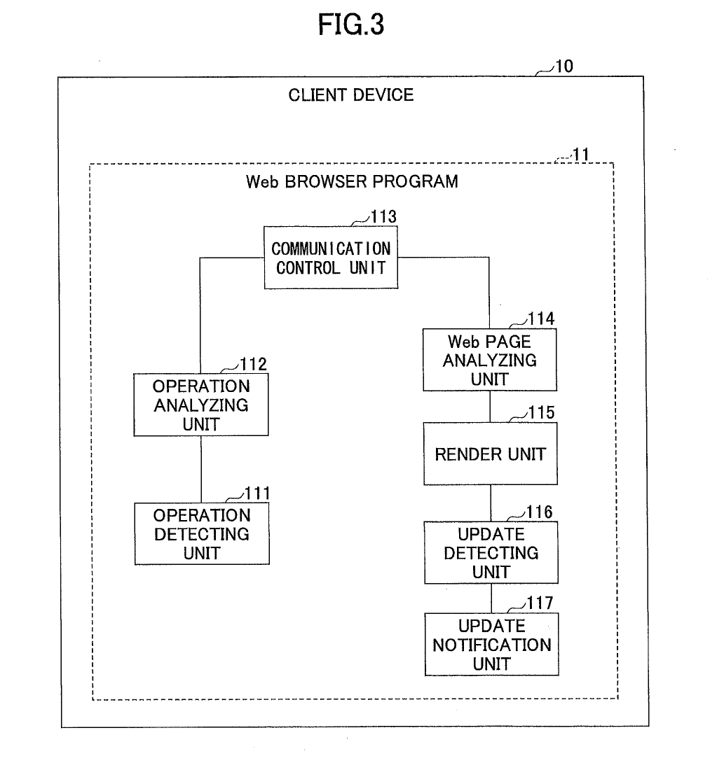

FIG. 3 illustrates a software configuration of the client device 10 according to an embodiment of the present invention. In FIG. 3, in the client device 10, a web browser program 11 is installed. The web browser program 11 is mainly a program for causing the client device 10 to execute the displaying of a web page. In the present embodiment, the web browser program 11 is an example of the web page update notification program. The web browser program 11 causes the client device 10 to function as an operation detecting unit 111, an operation analyzing unit 112, a communication control unit 113, a web page analyzing unit 114, a render unit 115, an update detecting unit 116, and an update notification unit 117.

The operation detecting unit 111 detects an operation performed by the user in the screen for displaying the web page (hereinafter, “web browser”). An example of the user's operation is, for example, inputting a URL. The operation analyzing unit 112 activates a process according to the operation of the user. The communication control unit 113 controls communications with the web server 20. For example, the communication control unit 113 sends a request to acquire a web page to the web server 20, and receives a response including the web page, returned from the web server 20.

The web page analyzing unit 114 analyzes the definition contents of the web page received by the communication control unit 113. The render unit 115 renders the web page in the web browser based on the analysis results by the web page analyzing unit 114. The update detecting unit 116 detects the update of the web page that is the display object in the web browser. A web page that is the display object is the entire web page, including parts that are not displayed in the web browser (hidden parts).

Updating the web page means to update the display contents of some of the display elements (configuration elements) in the web page. The update notification unit 117 executes a process for notifying the update detected by the update detecting unit 116 to the user. For example, the update notification unit 117 displays the updated display elements (configuration elements) so as to be distinguished from other display elements (configuration elements) (so that the updated display elements may be identified among other display elements).

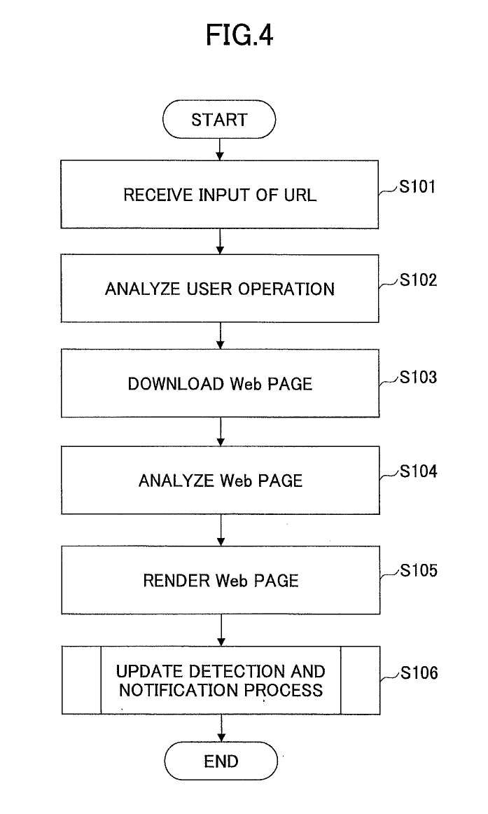

In the following, a description is given of processing procedures by the client device 10. FIG. 4 is a flowchart for describing processing procedures of a web page displaying process.

In step S101, the operation detecting unit 111 detects an input of a URL to the web browser. Next, the operation analyzing unit 112 analyzes the operation by the user (step S102). In this case, a URL has been input, and therefore it is determined that the loading (acquiring) of the web page identified by the URL is to be executed. Next, the communication control unit 113 acquires a web page relevant to the URL, from the web server 20 relevant to the input URL (step S103).

Next, the web page analyzing unit 114 analyzes the definition contents of the web page acquired by the communication control unit 113, and records the configuration information (layout information) of the web page as the analysis results in the memory device 103 (step S104). Analyzing of the definition contents of the web page corresponds to interpreting HTML, when the web page is described in HTML.

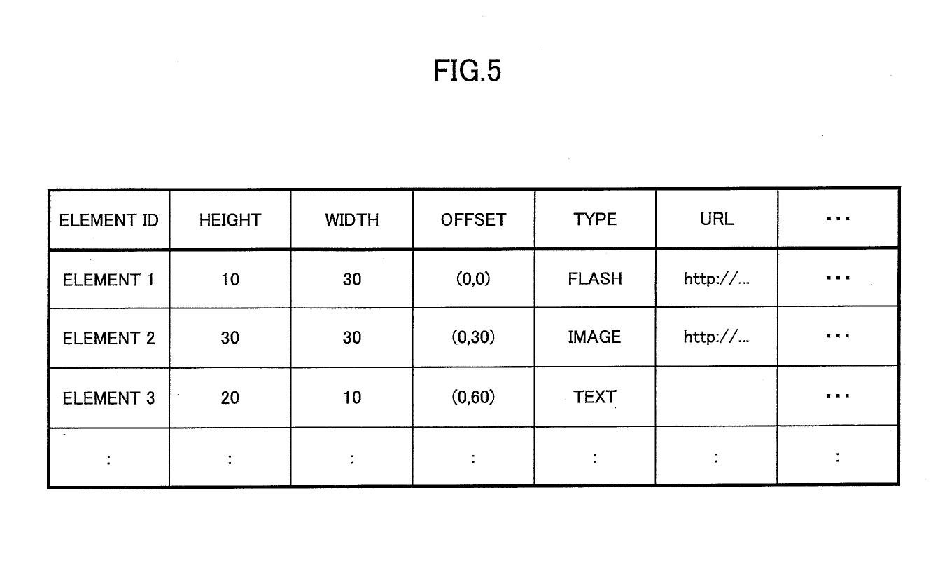

FIG. 5 illustrates an example of the configuration information of the web page. In FIG. 5, the configuration information includes, for each display element in the web page, an element ID, a height, a width, offset, type, and a URL.

The element ID is an identifier of the display element. The display element is an element to be displayed, constituting the web page. Examples of the display element are various types of data including video data such as flash contents, image data, and text data; and various elements (buttons, text boxes, etc.) for receiving input from the user.

The height and width are size information of the display element. The height is the size in the vertical direction and the width is the size in the horizontal direction. Offset is the position information of the display element. Offset is the coordinates of the top left point of the display element, when the top left point of the render area of the web browser is set as the origin (0, 0). The type is the type of the display element, which is distinguished according to the data format of the display element (image data, flash contents, text data, etc.). The URL is identification information of the arrangement position of the display element. That is to say, the HTML data is simply text data, and therefore, with respect to data other than text such as image data and video data, a URL indicating the arrangement position (location) is described. The web page analyzing unit 114 extracts the URL from the definition contents of the web page, and includes the URL in the configuration information. As for data without a URL such as text data (that is to say, data directly included in the definition contents of the web page), the value in the URL field is vacant.

When a script is included in the definition contents of the web page, the web page analyzing unit 114 also analyzes the script such as a Java (registered trademark) script.

The configuration information includes information used for rendering the web page. However, in FIG. 5, as a matter of convenience, part of the information (for example, information relevant to colors, etc.) is omitted.

Next, the render unit 115 renders the web page in the render area of the web browser, based on the configuration information (step S105). As the web page is rendered, the web page is displayed in the web browser. As for data such as image data and video data, which is not directly included in the definition contents of the web page and whose arrangement position is described by a URL, the render unit 115 downloads the data from an arrangement position identified by the URL and renders the data.

Next, the web browser waits for input of a user operation. Alternatively, when a script is included in the web page, the web page analyzing unit 114 executes the script. Therefore, even when there is no input of a user operation, the display contents of the web page may automatically change. In this state, the web browser executes a process of detecting the update of the web page that is presently displayed and notifying the detected update (step S106).

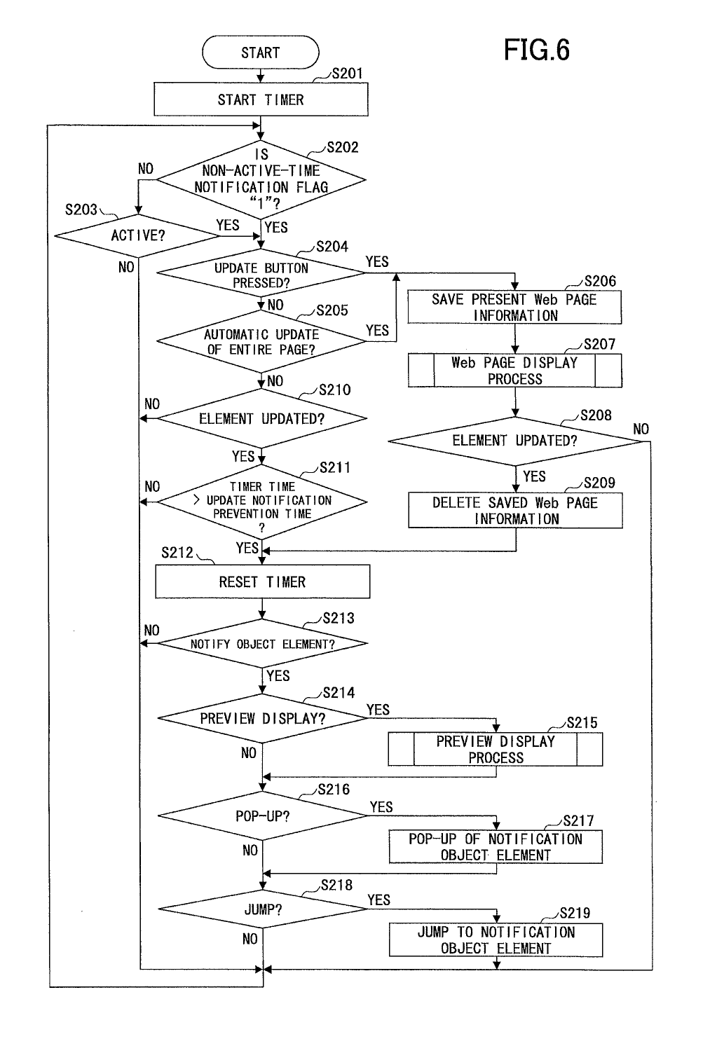

Next, details of step S106 are described. FIG. 6 is a flowchart describing processing procedures of the process of detecting the update of a web page and notifying the detected update.

In step S201 (that is to say, after completing the rendering of the web page), the update notification unit 117 starts measuring the time (step S201). Hereinafter, the time measured by the update notification unit 117 is referred to as the “timer time”. Next, the update detecting unit 116 determines whether the value of the non-active-time notification flag is “1” (step S202). A non-active-time notification flag is a parameter indicating whether the update of the web page is to be notified, when the web browser is not an active window. In the present embodiment, a non-active-time notification flag is recorded in the setting file of the web browser program 11. The setting file is saved in, for example, the secondary storage 102.

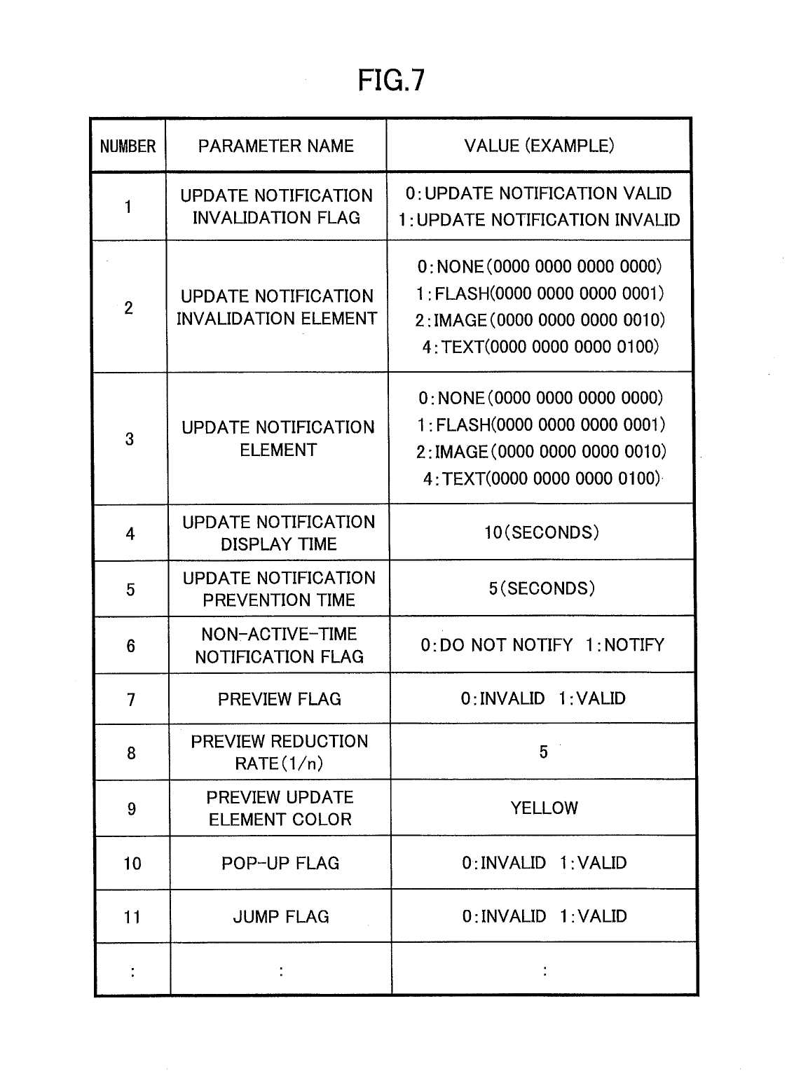

FIG. 7 illustrates the configuration of the setting file. FIG. 7 illustrates examples of a number, a parameter name, and a value for each parameter included in the setting file. The number is added as a matter of convenience in giving the description. Hereinafter, when reference is made to “an Nth parameter”, the value of N is specified by the value of the number.

In FIG. 7, the non-active-time notification flag is included as the sixth parameter. As the value of the non-active-time notification flag, “0” or “1” is set. “0” indicates not to make the notification. “1” indicates to make the notification. That is to say, “0” indicates not to make the notification when the web browser is not an active window, even when the web page that is displayed has been updated. “1” indicates to make the notification when the web page that is displayed has been updated, even when the web browser is not an active window. Meanings of the other parameters are described when each parameter is used.

An active window means a window that is an object of input and operations by the user, in a multi-window environment. Generally, an active window is displayed at the forefront among a plurality of windows.

When the value of the non-active-time notification flag is “1” (notify) (YES in step S202), the process proceeds to step S204. When the value of the non-active-time notification flag is “0” (do not notify) (NO in step S202), the update detecting unit 116 determines whether the web browser is an active window (step S203). It may be determined whether a window is an active window by calling a predetermined API (Application Program Interface) which is known.

When the web browser is not an active window (NO in step S203), the process returns to step S202. That is to say, the process of FIG. 6 is repeatedly executed as long as the web page relevant to the same URL is displayed. Meanwhile, when the web browser is an active window (YES in step S203), the process proceeds to step S204.

In step S204, the operation detecting unit 111 determines whether the update button has been pressed. An update button is a button that is pressed to acquire again the web page presently displayed from the web server 20. When the update button is not pressed (NO in step S204), the web page analyzing unit 114 determines whether the automatic updating of the entire web page has been executed (step S205). The automatic updating of the entire web page means that by executing a script included in the web page, a web page relevant to the same URL as the web page presently displayed is automatically loaded from the web server 20. Thus, by the automatic updating of the entire web page, the same effects as the case of pressing the update button are attained.

When the update button is pressed (YES in step S204, or when the automatic updating of the entire web page is executed (YES in step S205), the web page analyzing unit 114 saves the configuration information of the web page before the update (see FIG. 5) in the secondary storage 102 or the memory device 103 (step S206). Next, with regard to the same URL as that of the web page before the update, the same process as those of steps S103 through S105 of FIG. 4 are executed (step S207). As a result, a web page (web page after the update) relevant to the same URL as that of the web page that has been displayed is acquired from the web server 20, and the acquired web page is displayed on the web browser. In this process, the configuration information relevant to the web page after the update is generated in the memory device 103.

Next, the update detecting unit 116 compares the configuration information of the web page before the update with the configuration information of the web page after the update, to determine whether a display element has been updated (step S208). For example, it is determined whether there is a display element that is not included in the configuration information of the web page before the update but included in the configuration information of the web page after the update, and whether there is a display element that is included in both the configuration information of the web pages before and after the update but the size information, the position information, or the contents of the data is different. The contents of the data are, for example, the binary data itself with respect to image data and flash contents (video data).

When the update detecting unit 116 determines that no display elements have been updated (NO in step S208), step S202 and onward are repeated. When the update detecting unit 116 determines that the display element has been updated (YES in step S208), the update detecting unit 116 deletes the configuration information of the web page before the update from the save destination (step S209), and the process proceeds to step S212. In this case, for example, the update detecting unit 116 records the element ID of the updated display element in the memory device 103.

Meanwhile, when the update button is not pressed, and the automatic update of the entire web page is not performed (NO in step S205), the update detecting unit 116 determines whether each of the display elements have been separately updated (step S210). For example, according to Ajax (Asynchronous Java (registered trademark) Script+XML), it is possible to update the display contents of some of the display elements in the web page by communicating the web server, without reloading the entire web page. In step S210, it is determined whether there has been such an update in units of display elements. For example, such an update may be detected by monitoring the communication control unit 113, the web page analyzing unit 114, or the render unit 115. This is because when such an update is performed, communication and rendering are performed for some of the display elements. The update detecting unit 116 records the element ID of the display element determined as being updated (for which an update is detected), in the memory device 103.

When the display element is updated (YES in step S210), the update notification unit 117 determines whether the timer time has passed an update notification prevention time (step S211). In the present embodiment, the update notification prevention time is included as a fifth parameter in the setting file. The update notification prevention time is a parameter for excluding display elements that are frequently updated, such as a banner advertisement, from the objects for notifying the update. That is to say, when the update notification prevention time has not passed the render completion time or the previous update detection time (last update detection time), even when an update is detected, the process of notifying the update is not performed.

When the timer time has passed the update notification prevention time (YES in step S211), the update notification unit 117 resets the timer time (step S212). That is to say, the timer time is initialized to “0”. Next, the update notification unit 117 determines whether the display element whose element ID has been recorded in step S208 or step S210 (that is to say, a display element for which an update is detected; hereinafter, “notify candidate element”), is an object for notifying an update (whether the update is to be notified) (step S213). It is determined whether the display element is a notification object based on the first, second, and third parameters in the setting file (i.e., an update notification invalidation flag, an update notification invalidation element, and an update notification element).

The update notification invalidation flag is a parameter for indicating whether the update notifying function of a display element is invalid.

As the value of the update notification invalidation flag, “0” or “1” is set. “0” indicates that the update notifying function is valid. “1” indicates that the update notifying function is invalid. The update notification invalidation flag is given for all display elements.

The update notification invalidation element is a parameter indicating the object for invalidating the update notifying function, in units of the type of display element. That is to say, the update notification invalidation element is an example of information indicating the display of the notifying of the update for each type of display element. FIG. 7 illustrates an example where bit strings, in which one bit is allocated to each type of display element, are the value of the update notification invalidation element. For example, the first bit is allocated to flash contents, the second bit is allocated to image data, and the third bit is allocated to text data. As for the element type whose allocated bit value is “1”, the update notifying function is invalidated. That is to say, such an element type is excluded from the objects for notifying updates. By setting a bit string as the value of the update notification invalidation element, it is possible to efficiently manage values in a case where the update notifying function is invalidated with respect to a plurality of element types. For example, when the update notifying function is invalidated for the flash contents and the image data, “0000000000000011” is set as the value of the update notification invalidation element.

The update notification element is a parameter indicating the object for validating the update notifying function, in units of the type of display element. That is to say, the update notification element is an example of information indicating the display of the notifying of the update for each type of display element. The method of specifying the value of the update notification element is the same as that of the update notification invalidation element. As for the element type whose allocated bit value is “1”, the update notifying function is validated. That is to say, such an element type is set as an object for notifying the update.

Note that by using the update notification invalidation element and the update notification element, it is possible to set whether to notify the update in units of the type of display element. Therefore, display elements such as banner advertisements, which are frequently updated and whose update need not be notified, may be excluded from the objects for notifying the update. As a result, it is possible to avoid a case where updates are frequently notified and the user's work is disrupted.

In the present embodiment, the inferior-to-superior relationship of the three parameters, i.e., the update notification invalidation flag, the update notification invalidation element, and the update notification element, is defined as follows. update notification element>update notification invalidation flag>update notification invalidation element

The above relationship indicates that even when the value of the update notification invalidation flag is “1” (update notification invalid) for display elements belonging to a certain element type, when the bit value of the update notification element is “1” for display elements belonging to the certain element type, the update notifying function is validated for display elements belonging to the certain element type. Furthermore, the above relationship indicates that when there are inconsistent values set for the update notification element and the update notification invalidation element, the value of the update notification element is applied. However, the above relationship is one example. Therefore, for example, the values of the update notification element and the update notification invalidation element may be handled as valid values only when the update notification invalidation flag is “0” (update notification valid).

In step S213 described above, the update notification unit 117 refers to the configuration information to determine the type of notification candidate element. The update notification unit 117 determines the validity of the update notifying function (whether the update is to be notified) for each notification candidate element, based on the result of the determination of step S213, and the values of the update notification invalidation flag, the update notification invalidation element, and the update notification element. A notification candidate element whose update notifying function is determined as being valid (update is to be notified), is hereinafter referred to as a “notification object element”.

When there is at least one notification object element (YES in step S213), the update notification unit 117 determines whether to perform preview display (step S214). Preview display is a format of notifying the update of the display element. In preview display, the entire web page is displayed in a reduced size, and the notification object elements are displayed so as to be distinguishable from other display elements in the reduced web page. The determination of whether to perform preview display is made based on the value of a preview flag, which is the seventh parameter in the setting file. That is to say, when the value of the preview flag is “0”, it is determined that preview display is not to be performed. When the value of the preview flag is “1”, it is determined that preview display is to be performed.

When it is determined that preview display is to be performed (YES in step S214), the update notification unit 117 executes a preview display process (step S215). Details of the preview display process are given below.

Next, the update notification unit 117 determines whether the notification object element is to be displayed by pop-up (pop-up displayed) (step S216). Pop-up display is a format of notifying the update of the display element. The determination of whether to perform pop-up display is made based on the value of a pop-up flag, which is the tenth parameter in the setting file. That is to say, when the value of the pop-up flag is “0”, it is determined that pop-up display is not to be performed. When the value of the pop-up flag is “1”, it is determined that pop-up display is to be performed.

When it is determined to perform pop-up display (YES in step S216), the update notification unit 117 generates image data of the notification object element, and causes the display device 106 to display the screen including the generated data (pop-up screen) (step S217). The method of generating the image data of the display element may be performed according to known technology. As to a video such as flash contents, an image at a certain time point may be included in the pop-up screen. As a pop-up screen including the image of the notification object element is displayed, the user may immediately and easily recognize the updated display element. Furthermore, even when the size of the web page is larger than the render area of the web browser and the updated display element is not included in the render area due to the scroll position, the display element may be notified to the user.

Next, the update notification unit 117 determines whether to jump to the notification object element (step S218). Jumping is a format of notifying the update of the display element. The determination of whether to execute jumping is made based on the value of a jump flag, which is the eleventh parameter in the setting file. That is to say, when the value of the jump flag is “0”, it is determined not to execute jumping. When the value of the jump flag is “1”, it is determined to execute jumping.

When it is determined to execute jumping (YES in step S218), the update notification unit 117 scrolls the web page so that the position of the notification object element indicated by offset matches the top edge of the render area of the web browser (step S219). As a result, the user may immediately and easily recognize the updated display element. Furthermore, even when the size of the web page is larger than the render area of the web browser and the updated display element is not included in the render area due to the scroll position, the display element may be notified to the user. Note that the position of the jump destination of the notification object element may not be the top edge of the render area. For example, the position may be the center of the render area.

When preview display or pop-up display is performed, the update notification unit 117 sets the preview screen or the pop-up screen has “hidden”, when an update notification display time has passed after starting the preview display or pop-up display. The update notification display time is the third parameter in the setting file. As the preview screen or pop-up screen is automatically hidden, the user is saved of the burden of performing the operation of hiding the preview screen or pop-up screen. However, it may be possible to hide the preview screen or pop-up screen by user operation.

The processing procedure of FIG. 6 is an example where all notifying functions of preview display, pop-up display, and jump are executed for the same update. However, there may be an example where when one of these notifying functions is executed, the other notifying functions are not executed.

Next, step S202 and onward are repeated. Furthermore, when it is determined that the display element is not updated (NO in step S208, NO in step S210), when the timer time has not passed the update notification prevention time (NO in step S211), or when there are no notification object elements (NO in step S213), none of the subsequent step are performed and step S202 and onward are repeated.

Steps S204, S205, and S210 may not be executed in series. This is because the pressing of the update button, the automatic loading of the web page by the script, and the separate updating of the display elements are performed in a non-synchronous manner.

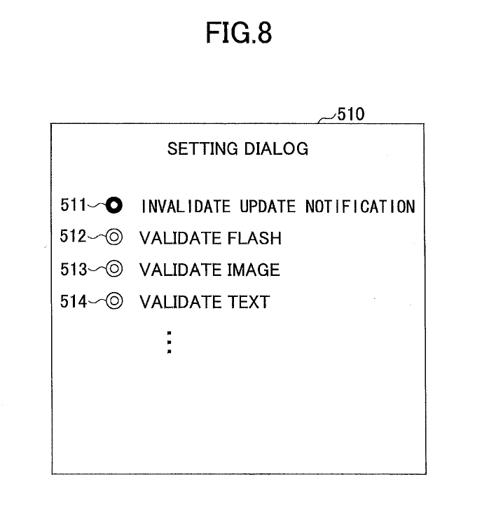

Furthermore, the settings of some of or all of the parameters in the setting file may be changed with a dialog that is displayed as a menu of the web browser is selected after the web browser is activated. In this case, the setting value of the parameter may be changed in units of activation of the web browser. For example, in the dialog indicated in FIG. 8, the values of the update notification invalidation flag and the update notification invalidation element may be set.

FIG. 8 illustrates a display example of a setting dialog of the update notification invalidation flag and the update notification invalidation element.

In a setting dialog 510 of FIG. 8, check buttons 511 through 514 are arranged. The check button 511 corresponds to the update notification invalidation flag. That is to say, when the check button 511 is checked, the value of the update notification invalidation flag is set as “1”. The check buttons of check button 512 and onward correspond to the update notification invalidation element. That is to say, when any one of the buttons of check button 512 and onward is checked, the value of the bit allocated to the element type corresponding to the checked check button is set as “1”.

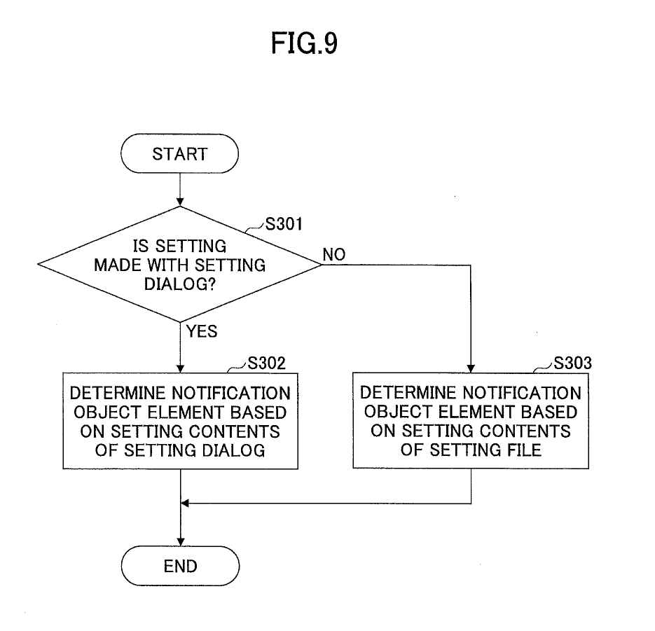

In the present embodiment, the value set in the setting dialog 510 is recorded in the memory device 103 separately from the setting contents of the setting file. In this case, in step S213 of FIG. 6, the setting contents in the setting dialog 510 and the setting contents in the setting file are handled as illustrated in FIG. 9, for example.

FIG. 9 is a flowchart for describing the relationship between the setting contents in the setting dialog 510 and the setting contents in the setting file.

First, the update notification unit 117 determines whether a setting is made with the setting dialog 510 (step S301). For example, it is determined whether a setting content set with the setting dialog 510 is recorded in the memory device 103. When a setting is made with the setting dialog 510 (YES in step S301), the update notification unit 117 determines the notification object element based on the setting contents of the setting dialog 510 (step S302). When a setting is not made with the setting dialog 510 (NO in step S301), the update notification unit 117 determines the notification object element based on the setting contents in the setting file (step S303).

The above flowchart is merely one example.

The setting contents of the setting dialog 510 may be applied to the setting file. In this case, the setting contents in the setting dialog 510 are not distinguished from the setting contents of the setting file, and therefore the notification object element may be determined based on the setting contents in the setting file.

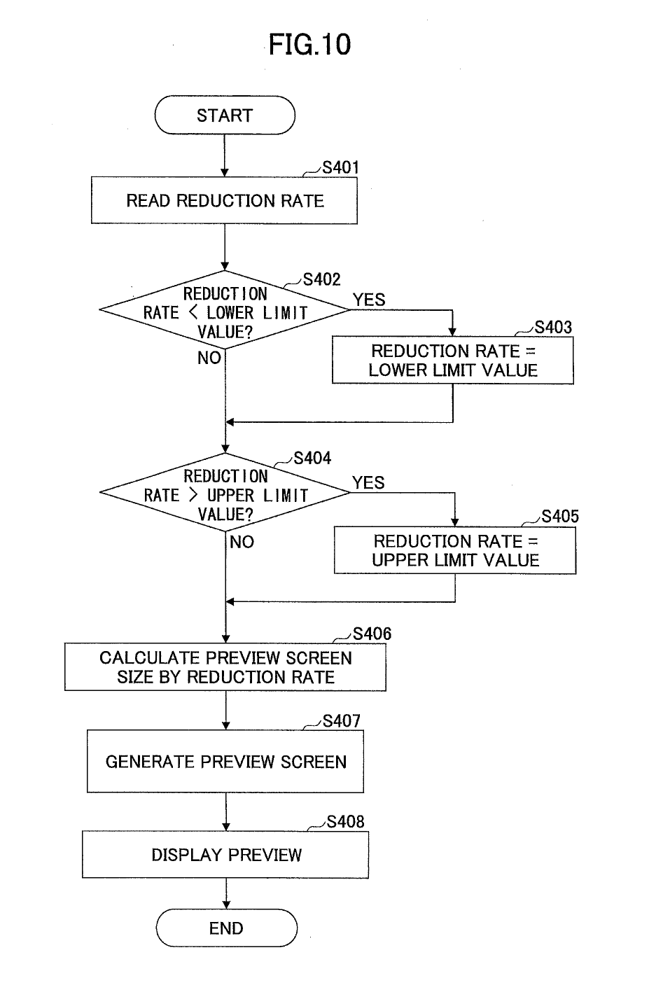

Next, details of step S215 of FIG. 6 are described. FIG. 10 is a flowchart for describing processing procedures of a preview display process.

In step S401, the update notification unit 117 reads the value of the preview reduction rate from the setting file. The preview reduction rate is the eighth parameter in the setting file. Next, the update notification unit 117 determines whether the preview reduction rate is less than a lower limit value (step S402). When the preview reduction rate is less than a lower limit value (YES in step S402), the update notification unit 117 corrects the preview reduction rate to the lower limit value (step S403). Next, the update notification unit 117 determines whether the preview reduction rate exceeds an upper limit value (step S404). When the preview reduction rate exceeds an upper limit value (YES in step S404), the update notification unit 117 corrects the preview reduction rate to the upper limit value (step S405). The lower limit value and the upper limit value of the preview reduction rate are set in advance.

Next, the update notification unit 117 applies the preview reduction rate (n) to the size of the web page presently being displayed, and calculates the size of the preview screen (step S406). That is to say, a size obtained by multiplying the size of the web page by 1/n is calculated as the size of the preview screen.

Next, the update notification unit 117 generates a preview screen (step S407). A preview screen is generated based on the configuration information of the web page that is presently displayed. Therefore, basically, the display contents of the preview screen are the same as the display contents of the web browser. However, in the preview screen, the sizes and offset values of all display elements are values reduced according to the preview reduction rate. Furthermore, in the web browser, the entire web page is not displayed, and the parts that are hidden are displayed by scrolling. Meanwhile, in the preview screen, the entire web page is included. As for a web page having a significantly large size, there may be cases where the size of the preview screen does not fit in the screen size of the display device 106, even when the web page is reduced according to the preview reduction rate. In consideration of such a case, the height and width of the maximum size of the preview screen may be defined, and the preview reduction rate may be corrected so that the size of the reduced preview screen fits in the maximum height and the maximum width.

Next, the update notification unit 117 causes the display device 106 to display the preview screen (step S408).

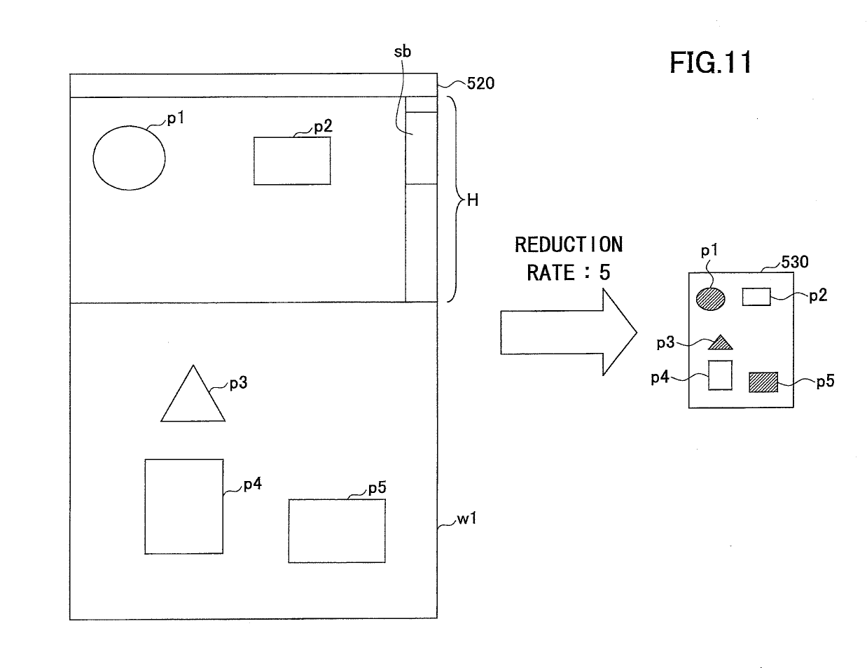

FIG. 11 illustrates a display example of the preview screen. In FIG. 11, a web page w1 displayed in a web browser 520 includes display elements p1 through p5. However, in the web browser 520, only the parts indicated by H are displayed, and the remaining parts may be displayed by operating a scroll bar sb.

Meanwhile, a preview screen 530 is obtained by reducing the web page w1 by 1/5. In the preview screen 530, basically the entire web page w1 is displayed. Furthermore, among the display elements included in the web page w1, the updated display elements (notification object elements) are indicated by hatching of a color specified as a preview update element color, so as to be distinguished from the other display elements. However, in FIG. 11, as a matter of convenience, the notification object elements are indicated only by hatching. That is to say, FIG. 11 illustrates a case where the display elements p1, p3, and p5 are the notification object elements. The preview update element color is the ninth parameter in the setting file.

As described above, according to the preview screen 530, the notification object elements are recognized at a glance. Furthermore, the positions of the notification object elements in the web page w1 are easily recognized. Furthermore, even when the notification object elements are not included in the render area due to the scroll position, the notification object elements are notified to the user.

As described above, according to the present embodiment, the update of some of the display elements (configuration elements) included in the web page displayed in the web browser is immediately notified to the user. Particularly, changes in the display state of the web page according to preview display, pop-up display, and jumping in the web page have a sufficient visual effect for attracting the user's attention. Therefore, in a multi-window environment, the update (changes) in the web page may be appropriately notified to a user operating a window other than the web browser.

Furthermore, the updated display elements (configuration elements) are displayed in a state that is visually distinguishable from display elements that are not updated (a display state that may be identified by the user). Therefore, even when the size of the web page is gigantic, the user may immediately recognize the updated portions.

According to an aspect of the embodiments, the updated portion of a web page being displayed by a web browser is immediately notified to the user.

The present invention is not limited to the specific embodiments described herein, and variations and modifications may be made without departing from the scope of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing an update notification program that causes a computer to execute a process comprising:
detecting at least one updated configuration element of a plurality of configuration elements of a web page based on content of communication of a web browser and a web server that provides the plurality of configuration elements of the web page; and
displaying the updated configuration element differently from other configuration elements of the plurality of configuration elements. 20

2. The non-transitory computer-readable recording medium according to claim 1, wherein
the detecting includes detecting the at least one updated configuration element based on the content of communication of the web browser and the web server that provides the configuration elements for each of the configuration elements of the web page.

3. The non-transitory computer-readable recording medium according to claim 1, further comprising:
determining whether to notify the at least one updated configuration element that has been detected, based on information indicating whether to notify the update for each type of configuration element of the web page, the information being stored in a storage unit, wherein
the displaying includes displaying the at least one updated configuration element, which is determined to be notified, to be displayed differently from the other configuration elements.

4. The non-transitory computer-readable recording medium according to claim 1, further comprising:
determining not to display the at least one updated configuration element when the at least one updated configuration element is detected within a predetermined time from a last update.

5. A web page update notification device comprising:
a detecting unit configured to detect at least one updated configuration element of a plurality of configuration elements of a web page based on content of communication of a web browser and a web server that provides the plurality of configuration elements of the web page; and
a notifying unit configured to display the updated configuration element differently from other configuration elements of the plurality of configuration elements.

6. The web page update notification device according to claim 5, wherein
the detecting unit is configured to detect the at least one updated configuration element based on the content of communication of the web browser and the web server that provides the configuration elements for each of the configuration elements of the web page.

7. The web page update notification device according to claim 5, wherein
the notifying unit is configured to
determine whether to notify the at least one updated configuration element that has been detected, based on information indicating whether to notify the update for each type of configuration element of the web page, the information being stored in a storage unit, and
to display the at least one updated configuration element, which is determined to be notified, to be displayed differently from the other configuration elements.

8. The web page update notification device according to claim 5, further comprising:
a determining unit configured to determine not to display the at least one updated configuration element when the at least one updated configuration element is detected within a predetermined time from a last update.

9. A web page update notification method executed by a computer, the web page update notification method comprising:
detecting at least one updated configuration element of a plurality of configuration elements of a web page based on content of communication of a web browser and a web server that provides the plurality of configuration elements of the web page; and
displaying the updated configuration element differently from other configuration elements of the plurality of configuration elements.

10. The web page update notification method according to claim 9, wherein
the detecting includes detecting the at least one updated configuration element based on the content of communication of the web browser and the web server that provides the configuration elements for each of the configuration elements of the web page.

11. The web page update notification method according to claim 9, further comprising:
determining whether to notify the at least one updated configuration element that has been detected, based on information indicating whether to notify the update for each type of configuration element of the web page, the information being stored in a storage unit, wherein
the displaying includes displaying the at least one updated configuration element, which is determined to be notified, to be displayed differently from the other configuration elements.

12. The web page update notification method according to claim 9, further comprising:
determining not to display the at least one updated configuration element when the at least one updated configuration element is detected within a predetermined time from a last update.
